(19) United States
(12) Patent Application Publication
(10) Pub. No.: US 2024/0048333 A1
(43) Pub. Date: Feb. 8, 2024

(54) MULTIPLE DEFAULT BEAMS FOR MULTIPLE PDSCH/PUSCH AND MULTI-SLOT PDCCH MONITORING

(71) Applicant: Lenovo (Singapore) Pte. Ltd., New Tech Park (SG)

(72) Inventors: Ankit Bhamri, Rödermark (DE); Ali Ramadan Ali, Kraiburg am Inn (DE); Karthikeyan Ganesan, Kronberg im Taunus (DE); Alexander Johann Maria Golitschek Edler von Elbwart, Darmstadt (DE); Sher Ali Cheema, Ilmenau (DE)

(21) Appl. No.: 18/554,162

(22) PCT Filed: Apr. 5, 2022
(86) PCT No.: PCT/IB2022/053180

§ 371 Date: Oct. 5, 2023

Related U.S. Application Data
(60) Provisional application No. 63/170,955, filed on Apr. 5, 2021.

(51) Int. Cl. H04L 5/00; H04W 72/1273; H04W 72/232

(52) U.S. Cl. CPC H04L 5/0053; H04W 72/1273; H04W 72/232

(57) ABSTRACT

Apparatuses, methods, and systems are disclosed for associating default beams for multiple physical downlink shared channel and/or physical uplink shared channel (PDSCH/PUSCH). One apparatus includes a processor coupled to a transceiver, the processor and the transceiver configured to cause the apparatus to receive a control resource set (CORESET) configuration indicating a plurality of beams and a corresponding duration for each indicated beam for at least CORESET identifier (ID) and to monitor the at least one CORESET in different physical downlink control channel (PDCCH) monitoring occasions using different beams. Via the transceiver, the processor receives a first CORESET within a PDCCH transmission, the first CORESET scheduling multiple physical channel transmissions, and communicates with the RAN on the multiple scheduled physical channels using the plurality of beams associated with a lowest CORESET ID configured to the device.

### CROSS-REFERENCE TO RELATED APPLICATIONS

This application claims priority to United States Provisional Patent Application Number 63/170,955 entitled “MULTIPLE DEFAULT BEAMS FOR MULTIPLE PDSCH/PUSCH AND MULTI-SLOT PDCCH MONITORING” and filed on 5 Apr. 2021 for Ankit Bhamri, Ali Ramadan Ali, Karthikeyan Ganesan, Alexander Johann Maria Golitschek Edler von Elbwart and Sher Ali Cheema, which application is incorporated herein by reference.

### FIELD

The subject matter disclosed herein relates generally to wireless communications and more particularly relates to multiple default beams for multiple Physical Downlink Shared Channel (“PDSCH”) and/or Physical Uplink Shared Channel (“PUSCH”) (i.e., “PDSCH/PUSCH”) and multi-slot Physical Downlink Control Channel (“PDCCH”).

### BACKGROUND

Certain wireless networks may support Third Generation Partnership Project (“3GPP”) New Radio (“NR”, i.e., 5^{th} generation Radio Access Technology (“RAT”)) operation in frequency bands beyond 52.6 GHz (e.g., 52.6 GHz to 71 GHz). To extend NR operation beyond 52.6 GHz, beam-management and scheduling behavior may be modified for the higher frequency ranges.

### BRIEF SUMMARY

Disclosed are procedures for associating multiple default beams for multiple PDSCH/PUSCH and monitoring of same Control Resource Set (“CORESET”) on different beams in different monitoring occasions. Said procedures may be implemented by apparatus, systems, methods, or computer program products.

One method at a User Equipment (“UE”) includes receiving a CORESET configuration from a radio access network (“RAN”), said CORESET configuration indicating a plurality of beams and a corresponding duration for each indicated beam for at least CORESET identifier (“ID”), and monitoring the at least one CORESET in different Physical Downlink Control Channel (“PDCCH”) monitoring occasions using different beams. The method includes receiving a first CORESET within a PDCCH transmission, the first CORESET scheduling multiple physical channel transmissions and communicating with the RAN on the multiple scheduled physical channels using the plurality of beams associated with a lowest CORESET ID configured to the device. Here, communicating with the RAN on the multiple scheduled physical channels includes receiving a downlink transmission, transmitting an uplink transmission, or a combination thereof.

One method at a RAN includes transmitting a CORESET configuration from a UE, said CORESET configuration indicating a plurality of beams and a corresponding duration for each indicated beam for at least CORESET ID. The method includes transmitting a first CORESET within a PDCCH monitoring occasion, the first CORESET scheduling multiple physical channel transmissions, and communicating with the UE on the multiple scheduled physical channels using the plurality of beams associated with a lowest CORESET ID configured to the device. Here, communicating with the RAN on the multiple scheduled physical channels includes transmitting a downlink transmission, receiving an uplink transmission, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for associating multiple default beams for multiple PDSCH/PUSCH and monitoring of same CORESET on different beams in different monitoring occasions;

FIG. 2 is a diagram illustrating one embodiment of a New Radio (“NR”) protocol stack;

FIG. 3 is a diagram illustrating one embodiment of updating TCI/QCL/beam for multiple PDSCH based on multiple TCI/QCL/beams activated for scheduling CORESET;

FIG. 4 is a diagram illustrating one embodiment of updating TCI/QCL/beam for multiple PDSCH based on multiple TCI/QCL/beams activated for lowest CORESET ID;

FIG. 5 is a diagram illustrating one embodiment of updating TCI/QCL/beam for multiple PDSCH based on multiple TCI/QCL/beams activated for lowest CORESET ID for some PDSCHs, while multiple TCI/QCL/beams activated for scheduling CORESET for remaining PDSCHs;

FIG. 6 is a diagram illustrating one embodiment of updating TCI/QCL/beam for multiple PDSCH based on multiple TCI/QCL/beams activated for lowest CORESET ID for some PDSCHs, while applying TCI/QCL/beams indicated by DCI for remaining PDSCHs;

FIG. 7 is a diagram illustrating one embodiment of PDCCH monitoring using different TCI/QCL/beam for same CORESET in different monitoring occasions within a PDCCH monitoring period;

FIG. 8 is a diagram illustrating one embodiment of PDCCH monitoring using different TCI/QCL/beam for same CORESET in different monitoring occasions with association pattern period smaller than PDCCH monitoring period;

FIG. 9 is a diagram illustrating one embodiment of PDCCH monitoring using different TCI/QCL/beam for same CORESET in different monitoring occasions with association pattern period greater than PDCCH monitoring period;

FIG. 10 is a block diagram illustrating one embodiment of a user equipment apparatus that may be used for associating multiple default beams for multiple PDSCH/PUSCH and monitoring of same CORESET on different beams in different monitoring occasions;

FIG. 11 is a block diagram illustrating one embodiment of a network apparatus that may be used for associating multiple default beams for multiple PDSCH/PUSCH and monitoring of same CORESET on different beams in different monitoring occasions;

FIG. 12 is a flowchart diagram illustrating one embodiment of a first method for associating multiple default beams for multiple PDSCH/PUSCH and monitoring of same CORESET on different beams in different monitoring occasions; and

FIG. 13 is a flowchart diagram illustrating one embodiment of a second method for associating multiple default beams for multiple PDSCH/PUSCH and monitoring of same CORESET on different beams in different monitoring occasions.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for associating multiple default beams for multiple PDSCH/PUSCH and monitoring of same CORESET on different beams in different monitoring occasions. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For NR operation beyond 52.6 GHz, beam-management for multi-PDSCH/PUSCH scheduling will be important for efficient operation. Currently, multi-slot PDCCH monitoring and single DCI based scheduling for multiple PDSCH/PUSCH is being defined for NR operation between 52.6 GHz to 71 GHz. However, the timing associated with beam-based operation can be enhanced for the new, higher operating frequencies and new SCS (i.e., 480 kHz and/or 960 kHz) of NR. One issue being discussed is determining default beams/TCI/QCL when multiple PDSCHs are scheduled by single DCI. As used herein, a beam may be defined by a Quasi-Co-Location (“QCL”) assumption and/or by a Transmission Configuration Indicator (“TCI”) state. Accordingly, the terms “beam,” “QCL assumption,” and “TCI state” are used interchangeably within the present disclosure. Moreover, the term “TCI/QCL/beam” may be used in the following discussion to refer to a beam, a TCI state, and/or a QCL assumption.

In this disclosure, solutions are defined on how to assign/determine multiple default beams for multiple PDSCHs. Another aspect discussed herein is related to beams/TCI/QCL used for multi-slot PDCCH monitoring (i.e., CORESET) where one or multiple PDCCH monitoring occasions can span across a group of slots. Defined herein are procedures and related signaling to determine suitable beams for monitoring same CORESET across multiple monitoring occasions within a group of slots for multi-slot PDCCH monitoring.

Disclosed are solutions for associating multiple default beams for multiple PDSCH/PUSCH and monitoring of same CORESET on different beams in different monitoring occasions. In some embodiments, the below-described procedure and signaling may be performed to allow association of multiple default beams to be applied for multiple PDSCH/PUSCH scheduled by a single DCI. In some embodiments, the below-described procedure and signaling may be performed to allow monitoring of same CORESET on different beams in different monitoring occasions without additional Medium Access Control (“MAC”) Control Element (“CE”) activation

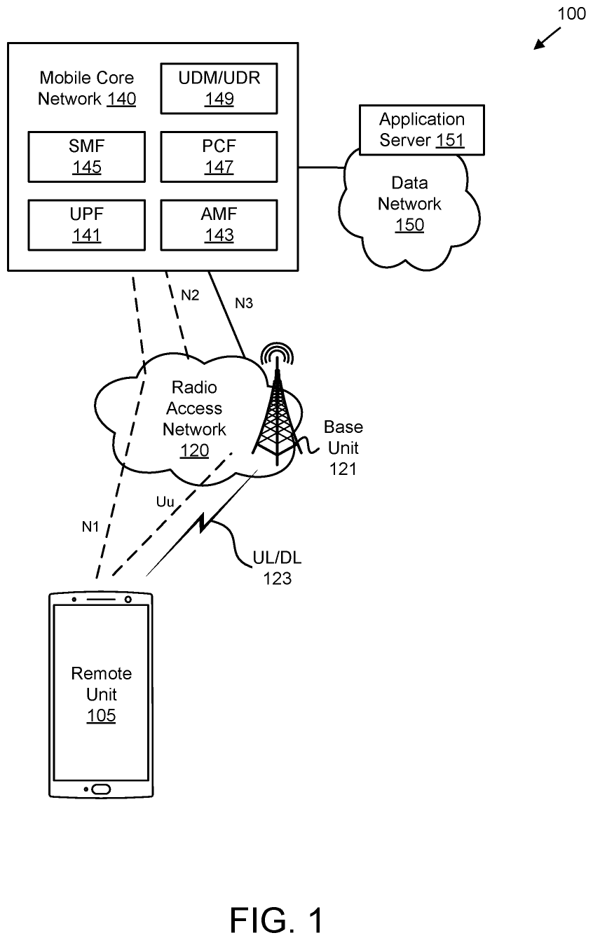

FIG. 1 depicts a wireless communication system 100 for associating multiple default beams for multiple PDSCH/PUSCH and monitoring of same CORESET on different beams in different monitoring occasions, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In some embodiments, the remote units 105 communicate with an application server 151 via a network connection with the mobile core network 140. For example, an application (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for associating multiple default beams for multiple PDSCH/PUSCH and monitoring of same CORESET on different beams in different monitoring occasions apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for associating multiple default beams for multiple PDSCH/PUSCH and monitoring of same CORESET on different beams in different monitoring occasions.

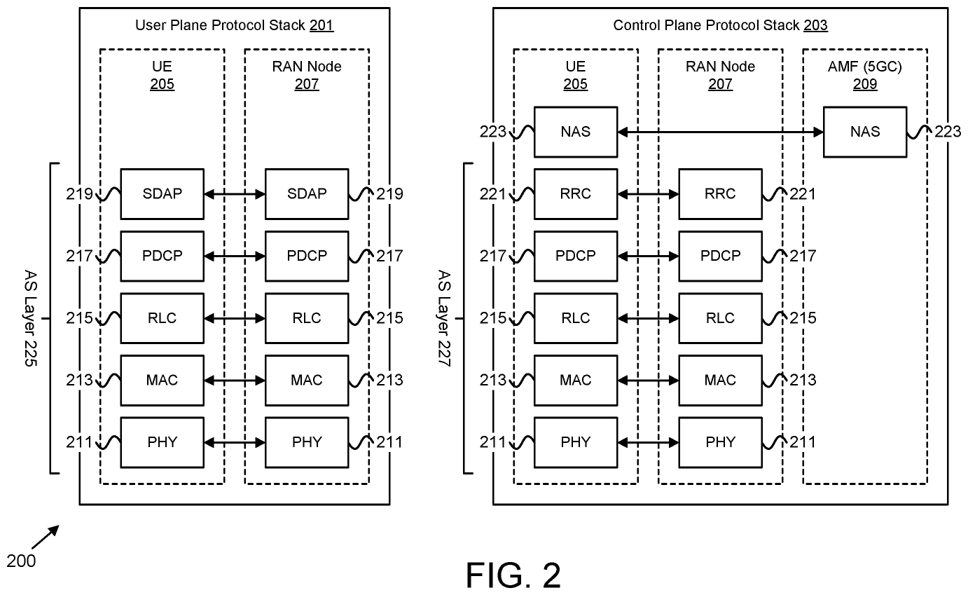

FIG. 2 depicts a protocol stack 200, according to embodiments of the disclosure. While FIG. 2 shows a UE 205, a RAN node 207 (e.g., a gNB) and a 5G core network 209 (containing, e.g., an AMF), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes the physical (“PHY”) layer 211, the Medium Access Control (“MAC”) sublayer 213, the Radio Link Control (“RLC”) sublayer 215, a Packet Data Convergence Protocol (“PDCP”) sublayer 217, and Service Data Adaptation Protocol (“SDAP”) layer 219. The Control Plane protocol stack 203 includes a PHY layer 211, a MAC sublayer 213, a RLC sublayer 215, and a PDCP sublayer 217. The Control Plane protocol stack 203 also includes a Radio Resource Control (“RRC”) layer 221 and a Non-Access Stratum (“NAS”) layer 223.

The AS layer 225 (also referred to as “AS protocol stack”) for the User Plane protocol stack 201 consists of at least the SDAP sublayer 219, PDCP sublayer 217, RLC sublayer 215 and the MAC sublayer 213, and the PHY layer 211. The AS layer 227 for the Control Plane protocol stack 203 consists of at least the RRC sublayer 221, PDCP sublayer 217, RLC sublayer 215, the MAC sublayer 213, and the PHY layer 211. The Layer-1 (“L1”) comprises the PHY layer 211. The Layer-2 (“L2”) is split into the SDAP sublayer 219, PDCP sublayer 217, RLC sublayer 215, and the MAC sublayer 213. The Layer-3 (“L3”) includes the RRC sublayer 221 and the NAS layer 223 for the control plane and includes, e.g., an Internet Protocol (“IP”) layer or PDU Layer (not depicted) for the user plane. L1 and L2 are referred to as “lower layers,” while L3 and above (e.g., transport layer, application layer) are referred to as “higher layers” or “upper layers.”

The physical layer 211 offers transport channels to the MAC sublayer 213. The MAC sublayer 213 offers logical channels to the RLC sublayer 215. The RLC sublayer 215 offers RLC channels to the PDCP sublayer 217. The PDCP sublayer 217 offers radio bearers to the SDAP sublayer 219 and/or RRC layer 221. The SDAP sublayer 219 maps QoS flows within a PDU Session to a corresponding Data Radio Bearer over the air interface and the SDAP sublayer 219 interfaces the QoS flows to the 5GC (e.g., to user plane function, UPF). The RRC layer 221 provides for the addition, modification, and release of Carrier Aggregation (“CA”) and/or Dual Connectivity (“DC”). The RRC layer 221 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

The NAS layer 223 is between the UE 205 and an AMF in the 5GC 509. NAS messages are passed transparently through the RAN. The NAS layer 223 is used to manage the establishment of communication sessions and for maintaining continuous communications with the UE 205 as it moves between different cells of the RAN. In contrast, the AS layers 225 and 227 are between the UE 205 and the RAN (i.e., RAN node 207) and carry information over the wireless portion of the network. While not depicted in FIG. 2, the IP layer exists above the NAS layer 223, a transport layer exists above the IP layer, and an application layer exists above the transport layer.

The MAC layer 213 is the lowest sublayer in the Layer-2 architecture of the NR protocol stack. Its connection to the PHY layer 211 below is through transport channels, and the connection to the RLC layer 215 above is through logical channels. The MAC layer 213 therefore performs multiplexing and demultiplexing between logical channels and transport channels: the MAC layer 213 in the transmitting side constructs MAC PDUs, known as transport blocks, from MAC Service Data Units (“SDUs”) received through logical channels, and the MAC layer 213 in the receiving side recovers MAC SDUs from MAC PDUs received through transport channels.

The MAC layer 213 provides a data transfer service for the RLC layer 215 through logical channels, which are either control logical channels which carry control data (e.g., RRC signaling) or traffic logical channels which carry user plane data. On the other hand, the data from the MAC layer 213 is exchanged with the PHY layer 211 through transport channels, which are classified as downlink or uplink Data is multiplexed into transport channels depending on how it is transmitted over the air.

The PHY layer 211 is responsible for the actual transmission of data and control information via the air interface, i.e., the PHY Layer 211 carries all information from the MAC transport channels over the air interface on the transmission side. Some of the important functions performed by the PHY layer 211 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 221. The PHY layer 211 performs transmissions based on transmission parameters, such as the modulation scheme, the coding rate (i.e., the modulation and coding scheme (“MCS”)), the number of physical resource blocks etc.

According to clause 10 in 3GPP Technical Specification (“TS”) 38.213, the following procedures are applicable for receiving PDCCH in NR Rel-15/16:

If a UE is provided parameter monitoringCapabilityConfig for a serving cell, then the UE obtains an indication to monitor PDCCH on the serving cell for a maximum number of PDCCH candidates and non-overlapping Control Channel Elements (“CCEs”). If the parameter monitoringCapabilityConfig=“r15monitoringcapability”, then the indication is per slot, as in Tables 10.1-2 and 10.1-3. Alternatively, if the parameter monitoringCapabilityConfig=“r16monitoringcapability”, then the indication is per span, as in Tables 10.1-2A and 10.1-3A.

However, if the UE is not provided parameter monitoringCapabilityConfig, then the UE monitors PDCCH on the serving cell for a maximum number of PDCCH candidates and non-overlapping CCEs per slot.

A UE may indicate a capability to monitor PDCCH according to one or more of the combinations (X,Y)=(2, 2), (4, 3), and (7, 3) per SCS configuration of μ=0 and μ=1. A “span” is a number of consecutive symbols in a slot where the UE is configured to monitor PDCCH. Each PDCCH monitoring occasion is within one span. If a UE monitors PDCCH on a cell according to combination (X,Y), then the UE supports PDCCH monitoring occasions in any symbol of a slot with minimum time separation of X symbols between the first symbol of two consecutive spans, including across slots. A span starts at a first symbol where a PDCCH monitoring occasion starts and ends at a last symbol where a PDCCH monitoring occasion ends, where the number of symbols of the span is up to Y.

If a UE indicates a capability to monitor PDCCH according to multiple (X,Y) combinations and a configuration of search space sets to the UE for PDCCH monitoring on a cell results to a separation of every two consecutive PDCCH monitoring spans that is equal to or larger than the value of X for one or more of the multiple combinations (X,Y), the UE monitors PDCCH on the cell according to the combination (X,Y), from the one or more combinations (X,Y), that is associated with the largest maximum number of M_{PDCCH}^{max,(X,Y),μ} and C_{PDCCH}^{max,(X,Y),μ} defined in Table 10.1-2A and Table 10.1-3A. The UE expects to monitor PDCCH according to the same combination (X,Y) in every slot on the active DL Bandwidth Part (“BWP”) of a cell.

A UE capability for PDCCH monitoring per slot or per span on an active DL BWP of a serving cell is defined by a maximum number of PDCCH candidates and non-overlapped CCEs the UE can monitor per slot or per span, respectively, on the active DL BWP of the serving cell.

According to clause 10.1 in 3GPP TS 38.213, following details for search space configuration for PDCCH monitoring is specified for NR Rel-15/16. For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by parameter controlResourceSetId or by parameter controlResourceSetld-v1610
a PDCCH monitoring periodicity of kₛ slots and a PDCCH monitoring offset of oₛ slots, by parameter monitoringSlotPeriodicityAndOffset
a PDCCH monitoring pattern within a slot, indicating first symbol(s) of the CORESET within a slot for PDCCH monitoring, by parameter monitoringSymbolsWithinSlot
a duration of Tₛ<kₛ slots indicating a number of slots that the search space set s exists by duration
a number of PDCCH candidates Mₛ^{(L)} per CCE aggregation level L by parameter aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that the Search Space set s is either a Common Search Space (“CSS”) set or a UE-specific Search Space (“USS”) set by parameter searchSpaceType

If search space set s is a CSS set, then the UE is provided the following by SearchSpace:
an indication by parameter dci-Format0-0-AndFormat1-0 to monitor PDCCH candidates for DCI format 0_0 and DCI format 1_0
an indication by parameter dci-Format2-0 to monitor one or two PDCCH candidates, or to monitor one PDCCH candidate per Radio Bearer (“RB”) set if the UE is provided parameter freqMonitorLocations for the search space set, for DCI format 2_0 and a corresponding CCE aggregation level
an indication by parameter dci-Format2-1 to monitor PDCCH candidates for DCI format 2_1
an indication by parameter dci-Format2-2 to monitor PDCCH candidates for DCI format 2_2
an indication by parameter dci-Format2-3 to monitor PDCCH candidates for DCI format 2_3
an indication by parameter dci-Format2-4 to monitor PDCCH candidates for DCI format 2_4
an indication by parameter dci-Format2-6 to monitor PDCCH candidates for DCI format 2_6

If search space set s is a USS set, then the UE is provided the following by SearchSpace:
an indication by parameter dci-Formats to monitor PDCCH candidates either for DCI format 0_0 and DCI format 1_0, or for DCI format 0_1 and DCI format 1_1, or
an indication by parameter dci-FormatsExt to monitor PDCCH candidates for DCI format 0_0 and DCI format 1_0, or for DCI format 0_1 and DCI format 1_1, or for DCI format 0_2 and DCI format 1_2, or, if a UE indicates a corresponding capability, for DCI format 0_1, DCI format 1_1, DCI format 0_2, and DCI format 1_2, or for DCI format 3_0, or for DCI format 3_1, or for DCI format 3_0 and DCI format 3_1

The UE is further provided, by SearchSpace, a bitmap by parameter freqMonitorLocations, if provided, to indicate an index of one or more RB sets for the search space set s, where the Most Significant Bit (“MSB”) kin the bitmap corresponds to RB set k−1 in the DL BWP. For RB set k indicated in the bitmap, the first Physical Resource Block (“PRB”) of the frequency domain monitoring location confined within the RB set is given by RB_{s0+k,DL}^{start,μ} N_{RB}^{offset}, where RB_{s0+k,DL}^{start,μ} is the index of first common RB of the RB set k (i.e., from 3GPP TS 38.214), and N_{RB}^{offset} by parameter rb-Offset or N_{RB}^{offset}=0 if parameter rb-Offset is not provided. For each RB set with a corresponding value of 1 in the bitmap, the frequency domain resource allocation pattern for the monitoring location is determined based on the first N_{RBG,set0}^{size} bits in parameter frequencyDomainResources provided by the associated CORESET configuration.

If the parameter monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} (per 3GPP TS 38.211) in a frame with number n_{f} if (n_{f}, Nₛₗₒₜ^{frame,μ}+n_{s,f}^{μ}−oₛ) modkₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots.

A USS at CCE aggregation level L∈{1,2,4,8,16} is defined by a set of PDCCH candidates for CCE aggregation level L.

Regarding PDCCH monitoring discussions for B52.6 in NR Rel-17, in one embodiment, the multi-slot PDCCH monitoring capability is defined using a fixed pattern of N slots. In another embodiment, the multi-slot PDCCH monitoring capability is defined using the Rel-16 capability (pdcch-Monitoring-r16, (X, Y) span) as the baseline to define the new capability. In a third embodiment, the multi-slot PDCCH monitoring capability is defined using a sliding window of N slots for defining multi-slot PDCCH monitoring capability.

Specific numbers for X, Y and N may depend on UE capability and gNB configuration. For example, N may be defined as follows: N=[4] slots for 480 kHz SCS and N=[8] slots for 960 kHz SCS. In another example, X may be defined as follows: X=[4] slots for 480 kHz SCS and X=[8] slots for 960 kHz SCS.

In certain embodiments, when using a fixed pattern of slot groups as the baseline to define the new capability: Each slot group may consist of X slots, where slot groups are consecutive and non-overlapping. Here, the capability indicates the Blind Detection and/or Control Channel Element (“BD/CCE”) budget within Y consecutive [symbols or slots] in each slot group.

In certain embodiments, when using an (X, Y) span as the baseline to define the new capability: X is the minimum time separation between the start of two consecutive spans. Here, the capability indicates the BD/CCE budget within a span of at most Y consecutive [symbols or slots], where Y≤X.

In certain embodiments, when using a sliding window of X slots as the baseline to define the new capability: The capability indicates the BD/CCE budget within the sliding window, where the sliding unit of the sliding window is [1] slot.

Regarding antenna ports and quasi co-location (“QCL”), the UE may be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a QCL relationship between one or two downlink reference signals and the Demodulation Reference Signal (“DM-RS”) ports of the PDSCH, the DM-RS port of PDCCH or the Channel State Information Reference Signal (“CSI-RS”) port(s) of a CSI-RS resource. Two antenna ports are said to be quasi-co-located if properties of the channel over which a symbol on one antenna port is conveyed can be inferred from the channel over which a symbol on the other antenna port is conveyed. The channel properties considered for quasi-co-location include, but are not limited to, Doppler shift, Doppler spread, average delay, delay spread, and/or Spatial Rx parameter.

The QCL relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE receives an activation command, as described in clause 6.1.3.14 of 3GPP TS 38.321, used to map up to 8 TCI states to the codepoints of the DCI field ‘Transmission Configuration Indication’ in one Component Carrier and/or Downlink Bandwidth Part (“CC/DL BWP”) or in a set of CCs/DL BWPs, respectively. When a set of TCI state IDs are activated for a set of CCs/DL BWPs, where the applicable list of Component Carriers (“CCs”) is determined by an indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause 6.1.3.24 of 3GPP TS 38.321, the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of 3GPP TS 38.321, only the first S activated codepoints are applied for DCI format 1_2.

When the UE would transmit a PUCCH with Hybrid Automatic Repeat Request Acknowledgement (“HARQ-ACK”) information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ} where m is the SCS configuration for the PUCCH. If parameter tci-PresentInDCI is set to ‘enabled’ or parameter tci-PresentDCI-1-2 is configured for the CORESET scheduling the PDSCH, and the time offset between the reception of the DL DCI and the corresponding PDSCH is equal to or greater than timedurationForQCL if applicable, after a UE receives an initial higher layer configuration of TCI states and before reception of the activation command, the UE may assume that the DM-RS ports of PDSCH of a serving cell are quasi co-located with the Synchronization Signal/Physical Broadcast Channel (“SS/PBCH”) block determined in the initial access procedure with respect to parameter qcl-Type set to ‘typeA’, and when applicable, also with respect to parameter qcl-Type set to ‘typeD’.

Regarding the default beam determination, if a UE is configured with the higher layer parameter tci-PresentInDCI that is set as ‘enabled’ for the CORESET scheduling the PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by parameter tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timedurationForQCL if applicable, where the threshold is based on reported UE capability (see 3GPP TS 38.306) for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the parameter TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timedurationForQCL, where the threshold is based on reported UE capability (see 3GPP TS 38.306).

When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH. When the UE is configured with CORESET associated with a search space set for cross-carrier scheduling and the UE is not configured with parameter enableDefaultBeamForCCS, the UE expects parameter tci-PresentInDCI is set as ‘enabled’ or parameter tci-PresentDCI-1-2 is configured for the CORESET, and if one or more of the TCI states configured for the serving cell scheduled by the search space set contains parameter qcl-Type set to ‘typeD’, the UE expects the time offset between the reception of the detected PDCCH in the search space set and the corresponding PDSCH is larger than or equal to the threshold timedurationForQCL.

Independent of the configuration of tci-PresentInDCI and tci-PresentDCI-1-2 in RRC connected mode, if the offset between the reception of the DL DCI and the corresponding PDSCH is less than the threshold timedurationForQCL and at least one configured TCI state for the serving cell of scheduled PDSCH contains qcl-Type set to ‘typeD’, then the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the parameter qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

If a UE is configured with parameter enableDefaultTCIStatePerCORESETPoolIndex and the UE is configured by higher layer parameter PDCCH-Config that contains two different values of CORESETPoolIndex in different ControlResourceSets, the UE may assume that the DM-RS ports of PDSCH associated with a value of parameter CORESETPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same CORESETPoolIndex, the UE is expected to prioritize the reception of PDCCH associated with that CORESET. This also applies to the intra-band CA case (when PDSCH and the CORESET are in different component carriers).

If a UE is configured with parameter enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier and the UE is configured with parameter enableDefaultBeam-ForCCS, then the parameter timedurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the value of timeDurationForQCL, where d is defined in 3GPP TS 38.214, clause 5.2.1.5.1a-1, otherwise d is zero.

For both the cases, when the offset between the reception of the DL DCI and the corresponding PDSCH is less than the threshold timedurationForQCL, and when the DL DCI does not have the TCI field present, the UE obtains its QCL assumption for the scheduled PDSCH from the activated TCI state with the lowest ID applicable to PDSCH in the active BWP of the scheduled cell.

NR Rel-15/16 beam-management procedures include initial beam acquisition, beam training, beam refinement and beam failure detection and recovery. Beam-management procedures rely heavily on constant/periodic exchange of reference signals and corresponding measurement reporting between the network (e.g., gNB) and UE for both UL and DL control/data channel transmissions. Consequently, the latency and overhead involved for such procedures is quite high. Moreover, the issues are expected to be further escalated for higher frequency ranges where the beams would be required to be very narrow in order to serve different use cases.

Thus, it is agreed to further study new parameter values for at least the parameter maxNumberRxTxBeamSwitchDL. In certain embodiments, there may be additional beam switching time delay d for triggering AP-CSI-RS when triggering PDCCH with 120 kHz or 480 kHz has a smaller subcarrier spacing than AP-CSI-RS.

It is agreed to study whether/how to introduce a beam switching gap between signals/channels. For multi-PDSCH scheduling with a single DCI, study the QCL assumption(s) the UE should apply for each PDSCH for the case when some of the scheduled PDSCHs have scheduling offset less than timedurationForQCL while some have scheduling offset equal to or greater than timedurationForQCL. For multi-PDSCH scheduling with a single DCI, study the QCL assumption(s) the UE should apply for each PDSCH for the case when all of the scheduled PDSCHs have scheduling offset less than timedurationForQCL. Note: If the current Rel-16 behavior would be extended to multiple-PDSCH scheduling, it could result in a different QCL assumption for each PDSCH due to the fact the that the CORESET with the lowest ID can be different for different slots, resulting in a potentially different TCI state for each slot.

The solutions described herein disclose, inter alia, procedures and signaling for multiple default beams/TCI/QCL for multiple PDSCH/PUSCH scheduling by single DCI, wherein a CORESET can be associated with multiple beams/TCI/QCL (e.g., for single- or multi-TRP) and corresponding duration for which each of the default beams/TCI/QCL is applied for multiple PDSCH(s)/PUSCHs transmissions. In various embodiments, for multi-slot PDCCH monitoring, a CORESET can be monitored on different beams for different monitoring occasions within a PDCCH monitoring period.

According to embodiments of the first solution, a UE is configured with CORESET, wherein the CORESET is associated with multiple TCI/QCL/beams activated by MAC CE and the duration (can be referred to as QCLduration1, QCLduration2 . . . .) for which each of the TCI/QCL/beam is applicable as default beam for multiple PDSCHs/PUSCHs scheduled by single DCI.

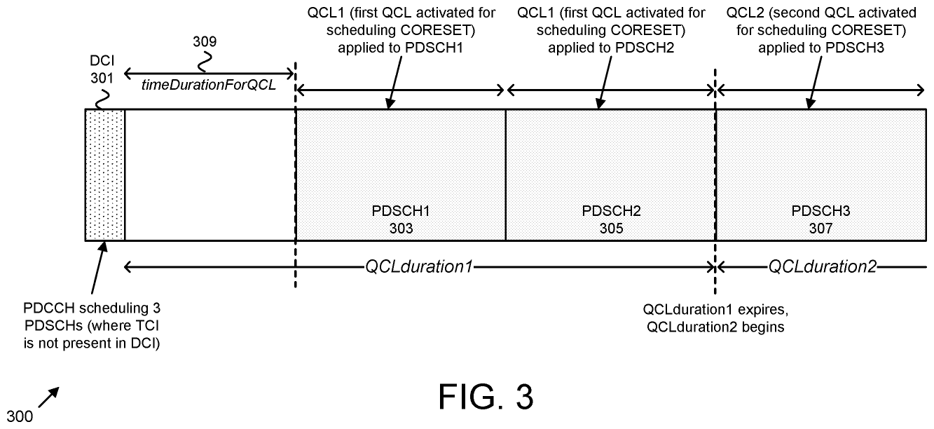

FIG. 3 depicts an exemplary frame structure 300 that illustrates updating TCI/QCL/beam for multiple PDSCH based on multiple TCI/QCL/beams activated for scheduling CORESET (when TCI is not present in DCI and scheduling offset is equal or greater than timedurationForQCL), according to embodiments of the disclosure. Here, the frame structure 300 depicts DL/UL communication between the UE 205 and the RAN node 207.

In one implementation of the first solution, the following applies where multiple PDSCHs are scheduled by a DCI format not having the TCI field present, and the time offset between A) the reception of the DL DCI and B) all the corresponding PDSCHs of a serving cell is equal to or greater than a threshold timedurationForQCL. Note that the threshold timedurationForQCL is based on reported UE capability, if applicable. In such scenarios, for determining PDSCH antenna port quasi co-location, the UE assumes that the TCI state or the QCL assumption for each of the PDSCH is based on the TCI/QCL/beam (i.e., associated with the CORESET used for the PDCCH transmission within the active BWP of the serving cell) that has TCIduration equal or greater than the scheduling offset of PDSCH with respect to the scheduling PDCCH.

The TCI/QCL/beam is applicable unless the TCIduration expires for that TCI/QCL/beam. Once the TCIduration expires for that TCI/QCL/beam, then the next TCI/QCL/beam is applied to the following PDSCH.

As depicted in FIG. 3, a DCI 301 is received by the UE 205 on PDCCH. Here, the PDCCH schedules 3 PDSCH transmission (i.e., first PDSCH 303 (denoted “PDSCH1”), second PDSCH 305 (denoted “PDSCH2”), and third PDSCH 307 (denoted “PDSCH3”)), where the TCI field is not present in the DCI 301. Because the time offset 309 between the DCI 301 and the first PDSCH 303 is greater than or equal to the threshold timedurationForQCL, the UE 205 is able to process the DCI 301 and switch beams before reception of the first PDSCH 303. Therefore, the UE 205 applies the TCI/QCL/beams activated for the scheduling CORESET, i.e., the CORESET used for the PDCCH transmission containing the DCI 301.

Accordingly, the UE 205 receives the first PDSCH 303 and the second PDSCH 305 using a first beam (e.g., associated with QCL1, i.e., the first QCL activated for the scheduling CORESET). However, because QCLduration1 expires before the third PDSCH 307 is scheduled, the UE 205 switches to the next beam (i.e., QCL assumption) and receives the third PDSCH 307 using the second beam (e.g., associated with QCL2, i.e., the second QCL activated for the scheduling CORESET).

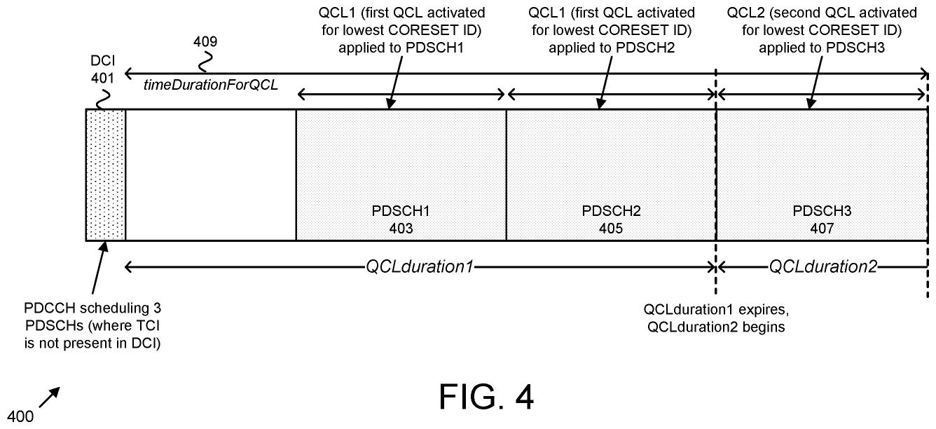

FIG. 4 depicts an exemplary frame structure 400 that illustrates updating TCI/QCL/beam for multiple PDSCH based on multiple TCI/QCL/beams activated for lowest CORESET ID (when TCI is not present in DCI and scheduling offset is less than timedurationForQCL), according to embodiments of the disclosure. Here, the frame structure 400 depicts DL/UL communication between the UE 205 and the RAN node 207.

In another implementation of the first solution, the following applies where multiple PDSCHs are scheduled by a DCI format (TCI field may or may not be present), and the time offset between the reception of the DL DCI and all the corresponding PDSCHs of a serving cell is less than a threshold timedurationForQCL. Note that the threshold timedurationForQCL is based on reported UE capability, if applicable. In such scenarios, for determining PDSCH antenna port quasi co-location, the UE 205 assumes that the TCI state or the QCL assumption for each of the PDSCH is based on the TCI/QCL/beam (i.e., associated with the lowest CORESET ID used for the PDCCH transmission within the active BWP of the serving cell) that has TCIduration equal or greater than the scheduling offset of PDSCH with respect to the scheduling PDCCH.

The TCI/QCL/beam is applicable unless the TCIduration expires for that TCI/QCL/beam. Once the TCIduration expires for that TCI/QCL/beam, then the next TCI/QCL/beam is applied to the following PDSCH.

As depicted in FIG. 4, a DCI 401 is received by the UE 205 on PDCCH. Here, the PDCCH schedules 3 PDSCH transmission (i.e., first PDSCH 403 (denoted “PDSCH1”), second PDSCH 405 (denoted “PDSCH2”), and third PDSCH 407 (denoted “PDSCH3”)). Because the time offset 409 between the DCI 401 and the first PDSCH 403 is less than the threshold timedurationForQCL, the UE 205 may not be able to process the DCI 401 and switch beams before reception of the first PDSCH 403. Therefore, the UE 205 applies the TCI/QCL/beams activated for the lowest CORESET ID. Because of the reception of all scheduled PDSCH is to occur before timedurationForQCL expires, it does not matter whether the TCI field is present in the DCI 401.

Accordingly, the UE 205 receives the first PDSCH 403 and the second PDSCH 405 using a first beam (e.g., associated with QCL1, i.e., the first QCL activated for the lowest CORESET ID). However, because QCLduration1 expires before the third PDSCH 407 is scheduled, the UE 205 switches to the next beam (i.e., QCL assumption) and receives the third PDSCH 407 using the second beam (e.g., associated with QCL2, i.e., the second QCL activated for the lowest CORESET ID).

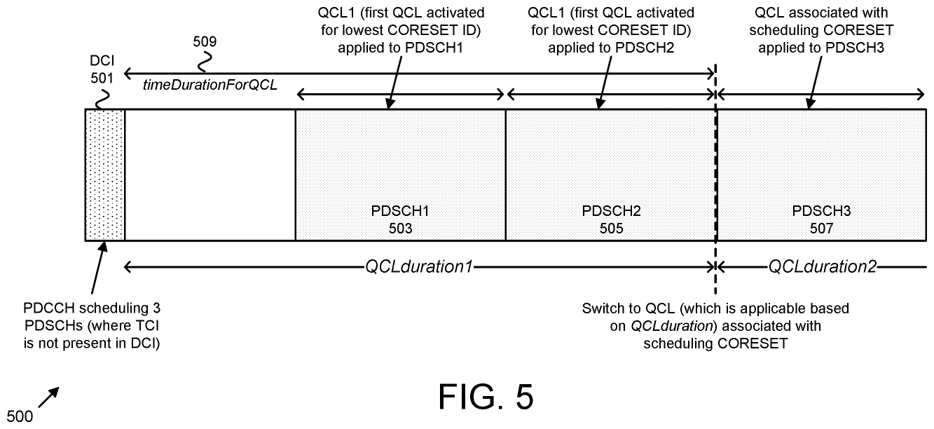

FIG. 5 depicts an exemplary frame structure 500 that illustrates updating TCI/QCL/beam for multiple PDSCH based on multiple TCI/QCL/beams activated for lowest CORESET ID for some PDSCHs, while multiple TCI/QCL/beams are activated for scheduling CORESET for remaining PDSCHs (where TCI is not present in DCI), according to embodiments of the disclosure. Here, the frame structure 500 depicts DL/UL communication between the UE 205 and the RAN node 207.

In another implementation of the first solution, the following applies where multiple PDSCHs are scheduled by a DCI format not having the TCI field present, and where the time offset between the reception of the DL DCI and some of the corresponding PDSCHs of a serving cell is less than a threshold timedurationForQCL. Note that the threshold timedurationForQCL is based on reported UE capability, if applicable. In such scenarios, for determining PDSCH antenna port quasi co-location, the UE 205 assumes that the TCI state or the QCL assumption for each of those corresponding PDSCHs is based on the TCI/QCL/beam (i.e., associated with the lowest CORESET ID used for the PDCCH transmission within the active BWP of the serving cell) that has TCIduration equal or greater than the scheduling offset of those corresponding PDSCHs with respect to the scheduling PDCCH.

The TCI/QCL/beam is applicable unless the TCIduration expires for that TCI/QCL/beam. Once the TCIduration expires for that TCI/QCL/beam, then the next TCI/QCL/beam is applied to the following PDSCH.

For the remaining PDSCHs, for which the time offset is equal or greater than threshold timedurationForQCL, the UE assumes that the TCI state or the QCL assumption for each of the PDSCH is based on the TCI/QCL/beam (associated with the scheduling CORESET used for the PDCCH transmission within the active BWP of the serving cell) that has TCIduration equal or greater than the scheduling offset of PDSCH with respect to the scheduling PDCCH.

As depicted in FIG. 5, a DCI 501 is received by the UE 205 on PDCCH. Here, the PDCCH schedules 3 PDSCH transmission (i.e., first PDSCH 503 (denoted “PDSCH1”), second PDSCH 505 (denoted “PDSCH2”), and third PDSCH 507 (denoted “PDSCH3”)), where the TCI field is not present in the DCI 501. Because the time offset 509 between the DCI 501 and the first PDSCH 503 is less than to the threshold timedurationForQCL, the UE 205 is able to process the DCI 501 and switch beams before reception of the first PDSCH 503. Therefore, the UE 205 applies the TCI/QCL/beams activated for the lowest CORESET ID for the reception of at least the first PDSCH 503. However, because the time offset 509 between the DCI 501 and the last scheduled PDSCH (i.e., third PDSCH 507) is greater than or equal to the threshold timedurationForQCL, the UE 205 is able to process the DCI 501 and switch beams before reception of the third PDSCH 507. Therefore, the UE 205 applies the TCI/QCL/beams activated for the scheduling CORESET (i.e., the CORESET used for the PDCCH transmission containing the DCI 501) for all PDSCH scheduled after the threshold timedurationForQCL (including the third PDSCH 607).

Accordingly, the UE 205 receives the first PDSCH 503 and the second PDSCH 505 using a first beam (e.g., associated with QCL1, i.e., the first QCL activated for the scheduling CORESET). However, because the time offset 509 between the DCI 501 and the last scheduled PDSCH (i.e., third PDSCH 507) is greater than or equal to the threshold timedurationForQCL, the UE 205 switches to a beam associated with the scheduling CORESET (i.e., which is applicable based on QCLduration) and receives the third PDSCH 507 using the beam associated with the QCL activated for the scheduling CORESET.

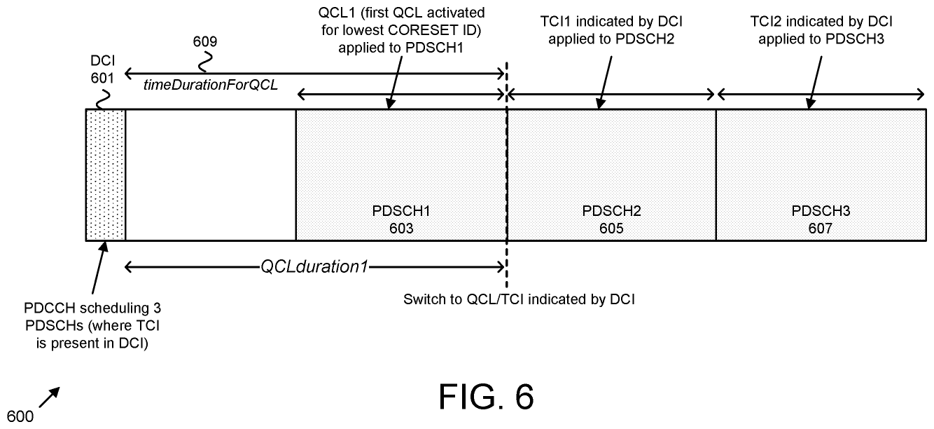

FIG. 6 depicts an example frame structure 600 that illustrates updating TCI/QCL/beam for multiple PDSCH based on multiple TCI/QCL/beams activated for lowest CORESET ID for some PDSCHs, while applying TCI/QCL/beams indicated by DCI for remaining PDSCHs (TCI present in DCI), according to embodiments of the disclosure. Here, the frame structure 600 depicts DL/UL communication between the UE 205 and the RAN node 207.

In another implementation of the first solution, the following applies where multiple PDSCHs are scheduled by a DCI format (where TCI field is present), and the time offset between the reception of the DL DCI and some of the corresponding PDSCHs of a serving cell is less than a threshold timedurationForQCL. Note that the threshold timedurationForQCL is based on reported UE capability, if applicable. In such scenarios, for determining PDSCH antenna port quasi co-location, the UE 205 assumes that the TCI state or the QCL assumption for each of those corresponding PDSCHs is based on the TCI/QCL/beam (associated with the lowest CORESET ID used for the PDCCH transmission within the active BWP of the serving cell) that has TCIduration equal or greater than the scheduling offset of those corresponding PDSCHs with respect to the scheduling PDCCH.

The TCI/QCL/beam is applicable unless the TCIduration expires for that TCI/QCL/beam. Once the TCIduration expires for that TCI/QCL/beam, then the next TCI/QCL/beam is applied to the following PDSCH.

For the remaining PDSCHs, for which the time offset is equal or greater than threshold timedurationForQCL, the UE applies the TCI state or the QCL assumption those remaining PDSCHs indicated by TCI codepoint in the scheduling DCI format.

As depicted in FIG. 6, a DCI 601 is received by the UE 205 on PDCCH. Here, the PDCCH schedules 3 PDSCH transmission (i.e., first PDSCH 603 (denoted “PDSCH1”), second PDSCH 605 (denoted “PDSCH2”), and third PDSCH 607 (denoted “PDSCH3”)), where the TCI field is present in the DCI 601. Because the time offset 609 between the DCI 601 and the first PDSCH 603 is less than to the threshold timedurationForQCL, the UE 205 is able to process the DCI 601 and switch beams before reception of the first PDSCH 603. Therefore, the UE 205 applies the TCI/QCL/beams activated for the lowest CORESET ID for the reception of at least the first PDSCH 603. However, because the time offset 609 between the DCI 601 and the last scheduled PDSCH (i.e., third PDSCH 607) is greater than or equal to the threshold timedurationForQCL, the UE 205 is able to process the DCI 601 and switch beams before reception of the third PDSCH 607. Therefore, the UE 205 applies the TCI/QCL/beams indicated in DCI 601 for all PDSCH scheduled after the threshold timedurationForQCL (including the third PDSCH 607).

Accordingly, the UE 205 receives the first PDSCH 603 and the second PDSCH 605 using a first beam (e.g., associated with QCL1, i.e., the first QCL activated for the scheduling CORESET). However, because the time offset 609 between the DCI 601 and the second PDSCH 605 is greater than or equal to the threshold timedurationForQCL, the UE 205 switches to the beam (i.e., TCI state or QCL assumption) indicated by the DCI 601 and receives the second PDSCH 605 and the third PDSCH 607 using the beam(s) by the DCI 601. Here, the second PDSCH 605 is received using a second beam (denoted as “TCI1”) indicated by the TCI field in the DCI 601 and the third PDSCH 607 is received using a third beam (denoted as “TCI2”) indicated by the TCI field in the DCI 601.

According to embodiments of the second solution, the UE 205 is configured with CORESET, wherein the CORESET is associated with multiple TCI/QCL/beams activated by MAC CE and the duration (can be referred to as QCLduration1, QCLduration2 . . . .) for which each of the TCI/QCL/beam is applicable for monitoring that CORESET in multiple monitoring occasions.

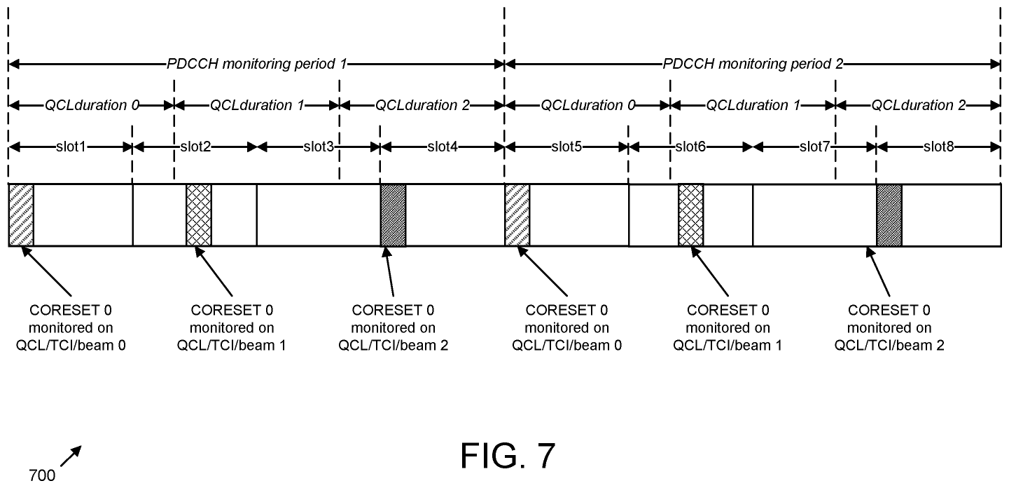

FIG. 7 depicts an example frame structure 700 that illustrates PDCCH monitoring using different TCI/QCL/beam for same CORESET in different monitoring occasions within a PDCCH monitoring period, according to embodiments of the disclosure. Here, the frame structure 700 depicts DL/UL communication between the UE 205 and the RAN node 207.

In one implementation of the second solution, the UE 205 is configured with multiple TCI/QCL/beams that are activated by MAC CE for a CORESET to monitor on different monitoring occasions within a PDCCH monitoring periodicity and/or multi-slot PDCCH duration. The associated duration/applicability time is used to determine which TCI/QCL/beam is used to monitor a CORESET on a given monitoring occasion. For every period, the same association of CORESET monitoring occasion and correspond TCI/QCL/beam is applied, as illustrated in FIG. 7.

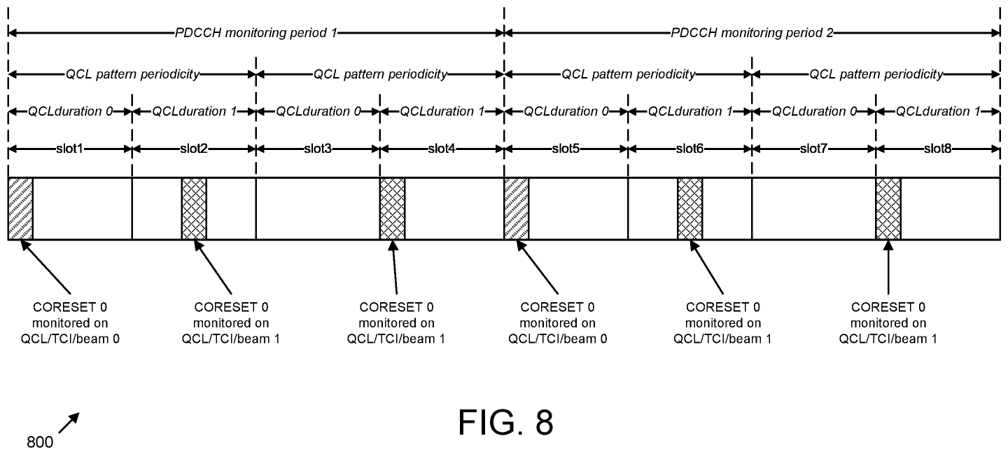

FIG. 8 depicts an example frame structure 800 that illustrates PDCCH monitoring using different TCI/QCL/beam for same CORESET in different monitoring occasions with association pattern period smaller than PDCCH monitoring period, according to embodiments of the disclosure. Here, the frame structure 800 depicts DL/UL communication between the UE 205 and the RAN node 207.

In another implementation of the second solution, the UE 205 is configured with multiple TCI/QCL/beams that are activated by MAC CE for a CORESET to monitor on different monitoring occasions, wherein the association pattern can be repeated with a periodicity independent of PDCCH monitoring periodicity. An association pattern between CORESET monitoring occasions and corresponding TCI/QCL/beams can be configured for a duration that can have period less than PDCCH monitoring period, as illustrated in FIG. 8.

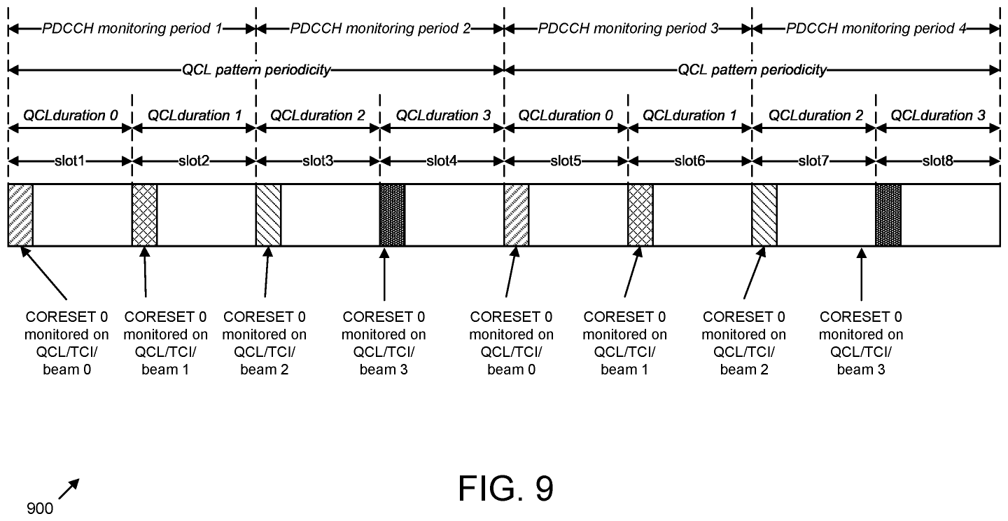

FIG. 9 depicts an example frame structure 900 that illustrates PDCCH monitoring using different TCI/QCL/beam for same CORESET in different monitoring occasions with association pattern period greater than PDCCH monitoring period, according to embodiments of the disclosure. Here, the frame structure 300 depicts DL/UL communication between the UE 205 and the RAN node 207.

In a further implementation of the second solution, the UE 205 is configured with multiple TCI/QCL/beams that are activated by MAC CE for a CORESET to monitor on different monitoring occasions, wherein the association pattern can be repeated with a periodicity independent of PDCCH monitoring periodicity. The same association pattern can be repeated with a configured periodicity is greater than the PDCCH monitoring periodicity, as illustrated in FIG. 9.

In another implementation of the second solution, the UE 205 is associated with multi TRP (two or even more) TCI/QCL/beams within a QCLduration, whereas different combinations of multi TRP TCI/QCL/beams may be used within a PDCCH monitoring. Such configurations are activated by MAC CE for a CORESET to monitor on different monitoring occasions, whereas any combination of association of pattern period with PDCCH monitoring period illustrated in FIGS. 7-9 may be used.

In some embodiments of the second solution, the UE 205 is associated with multiple beams associated with multiple TRPs based on the lowest CORESET ID associated for each of CORESETPoolIndex (i.e., associated with a TRP). In some embodiments of the second solution, when multiple TCI/QCL/beams from multiple TRPs can be applied within a certain duration, then the QCLduration 0 for first default beams is common regardless of the associated TRP, QCLduration 1 for second default beams is common regardless of associated TRP and so forth. In some embodiments of the second solution, a set of multiple TRP TCI/QCL/beams can be utilized for increased reliability/coverage for the same CORESET within a certain duration. These set of multiple TRP TCI/QCL/beams are switched after the corresponding QCLduration expires.

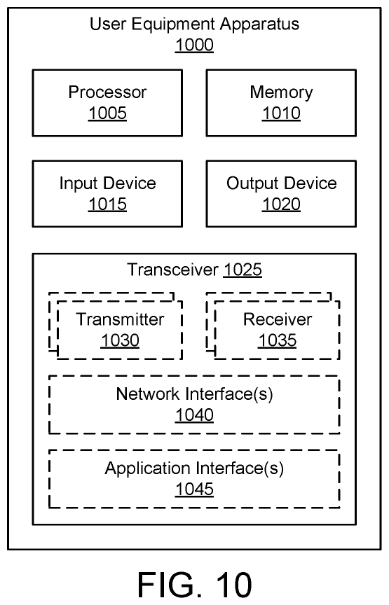

FIG. 10 depicts a user equipment apparatus 1000 that may be used for associating multiple default beams for multiple PDSCH/PUSCH and monitoring of same CORESET on different beams in different monitoring occasions, according to embodiments of the disclosure. In various embodiments, the user equipment apparatus 1000 is used to implement one or more of the solutions described above. The user equipment apparatus 1000 may be one embodiment of the remote unit 105, the UE 205, and/or the user equipment apparatus 1000, described above. Furthermore, the user equipment apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the user equipment apparatus 1000 may not include any input device 1015 and/or output device 1020. In various embodiments, the user equipment apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. In some embodiments, the transceiver 1025 communicates with one or more cells (or wireless coverage areas) supported by one or more base units 121. In various embodiments, the transceiver 1025 is operable on unlicensed spectrum. Moreover, the transceiver 1025 may include multiple UE panels supporting one or more beams. Additionally, the transceiver 1025 may support at least one network interface 1040 and/or application interface 1045. The application interface(s) 1045 may support one or more APIs. The network interface(s) 1040 may support 3GPP reference points, such as Uu, N1, PC5, etc. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025.

In various embodiments, the processor 1005 controls the user equipment apparatus 1000 to implement the above described UE behaviors. In certain embodiments, the processor 1005 may include an application processor (also known as “main processor”) which manages application-domain and operating system (“OS”) functions and a baseband processor (also known as “baseband radio processor”) which manages radio functions.

In various embodiments, the transceiver 1025 receives a CORESET configuration from a RAN, said CORESET configuration indicating a plurality of beams (or TCI states or QCL assumptions) and a corresponding duration for each indicated beam for at least CORESET ID. Via the transceiver 1025, the processor 1005 monitors the at least one CORESET in different PDCCH monitoring occasions using different beams and receives a first CORESET within a PDCCH transmission, the first CORESET scheduling multiple physical channel transmissions (i.e., PDCCH and/or PUSCH). Moreover, the processor 1005 communicates with the RAN on the multiple scheduled physical channels using the plurality of beams associated with a lowest CORESET ID configured to the device, where communicating with the RAN on the multiple scheduled physical channels includes receiving a downlink transmission, transmitting an uplink transmission, or a combination thereof.

In some embodiments, the first apparatus is configured with a time duration for QCL, where the multiple physical channel transmissions are scheduled by a single DCI that does not contain a TCI field, and where a time offset between reception of the DCI and the multiple physical channel transmissions is equal to or greater than the time duration for QCL. In such embodiments, communicating with the RAN includes applying a default beam (i.e., QCL assumption) associated with the first CORESET (i.e., the CORESET used for the PDCCH transmission). Here, the default beam has a TCI duration equal to or greater than the time offset between reception of the DCI and the multiple physical channel transmissions.

In certain embodiments, the first apparatus applies at least a second default beam when communicating with the RAN on the multiple scheduled physical channels. In such embodiments, the default beam for each scheduled instance of a physical channel is determined based on an associated time duration for the default beam.

In some embodiments, the first apparatus is configured with a time duration for QCL, where the multiple physical channel transmissions are scheduled by a single DCI, and where a time offset between reception of the DCI and the multiple physical channel transmissions is less than the time duration for QCL. In such embodiments, communicating with the RAN on the multiple scheduled physical channels includes applying multiple default beams associated with the first CORESET. Here, the default beams have a TCI duration equal to or greater than the time offset between reception of the DCI and the multiple physical channel transmissions.

In certain embodiments, the default beam for each scheduled instance of a physical channel is determined based on the associated time duration for the default beam.

In some embodiments, the first apparatus is configured with a time duration for QCL, where the multiple physical channel transmissions are scheduled by a single DCI that does not contain a TCI field, and where a time offset between reception of the DCI and a first portion (or subset) of the multiple physical channel transmissions is less than the time duration for QCL. In such embodiments, communicating with the RAN includes applying a default beam associated with the lowest CORESET ID for the first portion of the multiple physical channel transmissions and switching to a beam associated with the first CORESET for a remaining portion of the multiple physical channel transmissions.

In some embodiments, the first apparatus is configured with a time duration for QCL, where the multiple physical channel transmissions are scheduled by a single DCI that contains a TCI field indicating a set of beams, and where a time offset between reception of the DCI and a first portion (or subset) of the multiple physical channel transmissions is less than the time duration for QCL, wherein communicating with the RAN includes applying a default beam associated with the lowest CORESET ID for the first portion of the multiple physical channel transmissions and switching to the set of beam indicated by the DCI for a remaining portion of the multiple physical channel transmissions.

In some embodiments, the CORESET configuration includes a pattern of beams to monitor for a CORESET, where a periodicity of the pattern is equal to a periodicity of the PDCCH monitoring occasion. In such embodiments, for every PDCCH monitoring occasion (i.e., monitoring period) a same association of beams to monitor for the CORESET is applied within a PDCCH monitoring period.

In some embodiments, the CORESET configuration includes a pattern of beams to monitor for a CORESET, where a periodicity of the pattern is less than a periodicity of the PDCCH monitoring occasion. In such embodiments, for every PDCCH monitoring occasion a same association of beams to monitor for the CORESET is applied within a PDCCH monitoring period.

In some embodiments, the CORESET configuration includes a pattern of beams to monitor for a CORESET, where a periodicity of the pattern is greater than a periodicity of the PDCCH monitoring occasion. In such embodiments, an association of beams to monitor for the CORESET is applied over multiple PDCCH monitoring periods.

In some embodiments, the CORESET configuration includes a plurality of beams (or TCI states or QCL assumptions.

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to associating multiple default beams for multiple PDSCH/PUSCH and monitoring of same CORESET on different beams in different monitoring occasions. For example, the memory 1010 may store various parameters, panel/beam configurations, resource assignments, policies, and the like as described above. In certain embodiments, the memory 1010 also stores program code and related data, such as an operating system or other controller algorithms operating on the apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 1020 may include a wearable display separate from, but communicatively coupled to, the rest of the user equipment apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 communicates with one or more network functions of a mobile communication network via one or more access networks. The transceiver 1025 operates under the control of the processor 1005 to transmit messages, data, and other signals and also to receive messages, data, and other signals. For example, the processor 1005 may selectively activate the transceiver 1025 (or portions thereof) at particular times in order to send and receive messages.

The transceiver 1025 includes at least transmitter 1030 and at least one receiver 1035. One or more transmitters 1030 may be used to provide UL communication signals to a base unit 121, such as the UL transmissions described herein. Similarly, one or more receivers 1035 may be used to receive DL communication signals from the base unit 121, as described herein. Although only one transmitter 1030 and one receiver 1035 are illustrated, the user equipment apparatus 1000 may have any suitable number of transmitters 1030 and receivers 1035. Further, the transmitter(s) 1030 and the receiver(s) 1035 may be any suitable type of transmitters and receivers. In one embodiment, the transceiver 1025 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1025, transmitters 1030, and receivers 1035 may be implemented as physically separate components that access a shared hardware resource and/or software resource, such as for example, the network interface 1040.

In various embodiments, one or more transmitters 1030 and/or one or more receivers 1035 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 1030 and/or one or more receivers 1035 may be implemented and/or integrated into a multi-chip module. In some embodiments, other components such as the network interface 1040 or other hardware components/circuits may be integrated with any number of transmitters 1030 and/or receivers 1035 into a single chip. In such embodiment, the transmitters 1030 and receivers 1035 may be logically configured as a transceiver 1025 that uses one more common control signals or as modular transmitters 1030 and receivers 1035 implemented in the same hardware chip or in a multi-chip module.

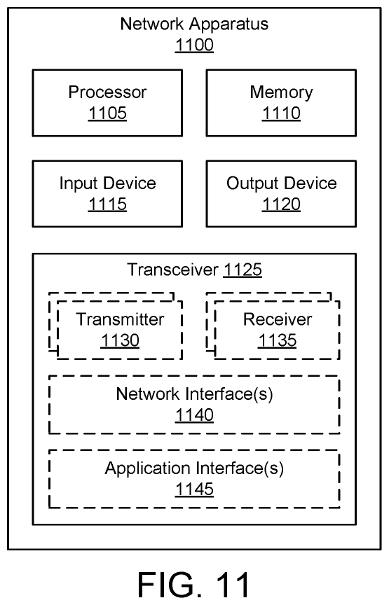

FIG. 11 depicts a network apparatus 1100 that may be used for associating multiple default beams for multiple PDSCH/PUSCH and monitoring of same CORESET on different beams in different monitoring occasions, according to embodiments of the disclosure. In one embodiment, network apparatus 1100 may be one implementation of a RAN device, such as the base unit 121 and/or RAN node 207, as described above. Furthermore, the network apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the network apparatus 1100 may not include any input device 1115 and/or output device 1120. In various embodiments, the network apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. Here, the transceiver 1125 communicates with one or more remote units 105. Additionally, the transceiver 1125 may support at least one network interface 1140 and/or application interface 1145. The application interface(s) 1145 may support one or more APIs. The network interface(s) 1140 may support 3GPP reference points, such as Uu, N1, N2 and N3. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a CPU, a GPU, an auxiliary processing unit, a FPGA, or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125.

In various embodiments, the network apparatus 1100 is a RAN node (e.g., gNB) that communicates with one or more UEs, as described herein. In such embodiments, the processor 1105 controls the network apparatus 1100 to perform the above described RAN behaviors. When operating as a RAN node, the processor 1105 may include an application processor (also known as “main processor”) which manages application-domain and operating system (“OS”) functions and a baseband processor (also known as “baseband radio processor”) which manages radio functions.

In some embodiments, via the transceiver 1125, the processor 1105 transmits a CORESET configuration to a UE, said CORESET configuration indicating a plurality of beams (or TCI states or QCL assumptions) and a corresponding duration for each indicated beam for at least CORESET ID, and also transmits a first CORESET within a PDCCH monitoring occasion, the first CORESET scheduling multiple physical channel transmissions (i.e., PDCCH and/or PUSCH). Via the transceiver 1125, the processor 1105 further communicates with the UE on the multiple scheduled physical channels using the plurality of beams associated with a lowest CORESET ID configured to the device, where communicating with the RAN on the multiple scheduled physical channels includes transmitting a downlink transmission, receiving an uplink transmission, or a combination thereof.

In some embodiments, the CORESET configuration includes a pattern of beams to monitor for a CORESET, where a periodicity of the pattern is equal to a periodicity of the PDCCH monitoring occasion. In such embodiments, for every PDCCH monitoring occasion (i.e., monitoring period) a same association of beams to monitor for the CORESET is applied within a PDCCH monitoring period.

In some embodiments, the CORESET configuration includes a pattern of beams to monitor for a CORESET, where a periodicity of the pattern is less than a periodicity of the PDCCH monitoring occasion. In such embodiments, for every PDCCH monitoring occasion a same association of beams to monitor for the CORESET is applied within a PDCCH monitoring period.

In some embodiments, the CORESET configuration includes a pattern of beams to monitor for a CORESET, where a periodicity of the pattern is greater than a periodicity of the PDCCH monitoring occasion. In such embodiments, an association of beams to monitor for the CORESET is applied over multiple PDCCH monitoring periods.

In some embodiments, the CORESET configuration includes a plurality of beams (or TCI states or QCL assumptions) associated with multiple Transmission-Reception Points in the RAN.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to associating multiple default beams for multiple PDSCH/PUSCH and monitoring of same CORESET on different beams in different monitoring occasions. For example, the memory 1110 may store parameters, configurations, resource assignments, policies, and the like, as described above. In certain embodiments, the memory 1110 also stores program code and related data, such as an operating system or other controller algorithms operating on the apparatus 1100.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, an LCD display, an LED display, an OLED display, a projector, or similar display device capable of outputting images, text, or the like to a user. As another, non-limiting, example, the output device 1120 may include a wearable display separate from, but communicatively coupled to, the rest of the network apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 includes at least transmitter 1130 and at least one receiver 1135. One or more transmitters 1130 may be used to communicate with the UE, as described herein. Similarly, one or more receivers 1135 may be used to communicate with network functions in the Public Land Mobile Network (“PLMN”) and/or RAN, as described herein. Although only one transmitter 1130 and one receiver 1135 are illustrated, the network apparatus 1100 may have any suitable number of transmitters 1130 and receivers 1135. Further, the transmitter(s) 1130 and the receiver(s) 1135 may be any suitable type of transmitters and receivers.

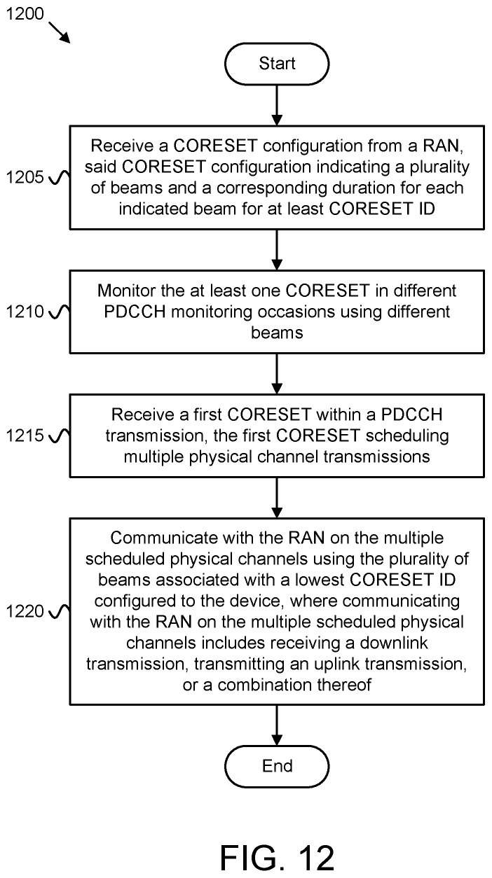

FIG. 12 depicts one embodiment of a method 1200 for associating multiple default beams for multiple PDSCH/PUSCH and monitoring of same CORESET on different beams in different monitoring occasions, according to embodiments of the disclosure. In various embodiments, the method 1200 is performed by a UE device, such as the remote unit 105, the UE 205, and/or the user equipment apparatus 1000, described above as described above. In some embodiments, the method 1200 is performed by a processor, such as a microcontroller, a microprocessor, a CPU, a GPU, an auxiliary processing unit, a FPGA, or the like.

The method 1200 begins and receives 1205 a CORESET configuration from a RAN, said CORESET configuration indicating a plurality of beams (or TCI states or QCL assumptions) and a corresponding duration for each indicated beam for at least CORESET ID. The method 1200 includes monitoring 1210 the at least one CORESET in different PDCCH monitoring occasions using different beams. The method 1200 includes receiving 1215 a first CORESET within a PDCCH transmission, the first CORESET scheduling multiple physical channel transmissions (i.e., PDSCH and/or PUSCH). The method 1200 includes communicating 1220 with the RAN on the multiple scheduled physical channels using the plurality of beams associated with a lowest CORESET ID configured to the device, where communicating with the RAN on the multiple scheduled physical channels includes receiving a downlink transmission, transmitting an uplink transmission, or a combination thereof. The method 1200 ends.

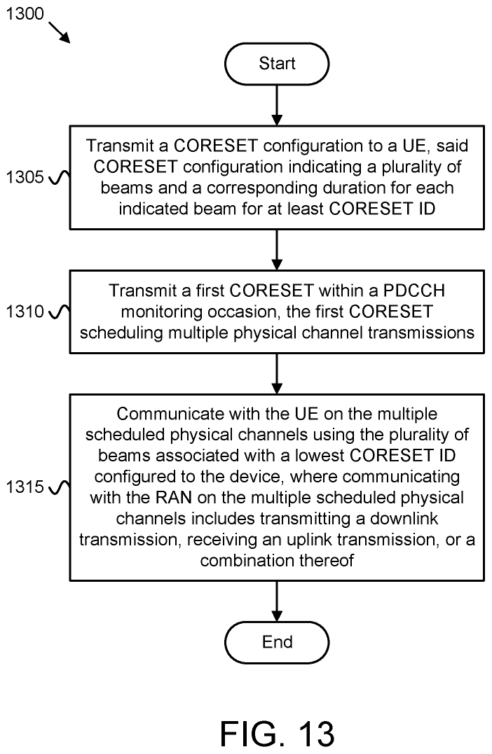

FIG. 13 depicts one embodiment of a method 1300 for associating multiple default beams for multiple PDSCH/PUSCH and monitoring of same CORESET on different beams in different monitoring occasions, according to embodiments of the disclosure. In various embodiments, the method 1300 is performed by an access network node, such as the base unit 121, the RAN node 207, and/or the network apparatus 1100, described above as described above. In some embodiments, the method 1300 is performed by a processor, such as a microcontroller, a microprocessor, a CPU, a GPU, an auxiliary processing unit, a FPGA, or the like.

The method 1300 begins and transmits 1305 a CORESET configuration to a UE, said CORESET configuration indicating a plurality of beams (or TCI states or QCL assumptions) and a corresponding duration for each indicated beam for at least CORESET ID. The method 1300 includes transmitting 1310 a first CORESET within a PDCCH monitoring occasion, the first CORESET scheduling multiple physical channel transmissions (i.e., PDSCH and/or PUSCH). The method 1300 includes communicating 1315 with the UE on the multiple scheduled physical channels using the plurality of beams associated with a lowest CORESET ID configured to the device, where communicating with the RAN on the multiple scheduled physical channels includes transmitting a downlink transmission, receiving an uplink transmission, or a combination thereof. The method 1300 ends.

Disclosed herein is a first apparatus for associating multiple default beams for multiple PDSCH/PUSCH and monitoring of same CORESET on different beams in different monitoring occasions, according to embodiments of the disclosure. The first apparatus may be implemented by a UE device, such as the remote unit 105, the UE 205, and/or the user equipment apparatus 1000, described above. The first apparatus includes a processor coupled to a transceiver, the processor and the transceiver configured to cause the first apparatus to receive a CORESET configuration from a RAN, said CORESET configuration indicating a plurality of beams (or TCI states or QCL assumptions) and a corresponding duration for each indicated beam for at least CORESET ID; to monitor the at least one CORESET in different PDCCH monitoring occasions using different beams; to receive a first CORESET within a PDCCH transmission, the first CORESET scheduling multiple physical channel transmissions (i.e., PDSCH and/or PUSCH); and to communicate with the RAN on the multiple scheduled physical channels using the plurality of beams associated with a lowest CORESET ID configured to the device. Here, communicating with the RAN on the multiple scheduled physical channels includes receiving a downlink transmission, transmitting an uplink transmission, or a combination thereof.

In some embodiments, the first apparatus is configured with a time duration for QCL, where the multiple physical channel transmissions are scheduled by a single DCI that does not contain a TCI field, and where a time offset between reception of the DCI and the multiple physical channel transmissions is equal to or greater than the time duration for QCL. In such embodiments, communicating with the RAN includes applying a default beam (i.e., QCL assumption) associated with the first CORESET (i.e., the CORESET used for the PDCCH transmission). Here, the default beam has a TCI duration equal to or greater than the time offset between reception of the DCI and the multiple physical channel transmissions.

In certain embodiments, the first apparatus applies at least a second default beam when communicating with the RAN on the multiple scheduled physical channels. In such embodiments, the default beam for each scheduled instance of a physical channel is determined based on an associated time duration for the default beam.

In some embodiments, the first apparatus is configured with a time duration for QCL, where the multiple physical channel transmissions are scheduled by a single DCI, and where a time offset between reception of the DCI and the multiple physical channel transmissions is less than the time duration for QCL. In such embodiments, communicating with the RAN on the multiple scheduled physical channels includes applying multiple default beams associated with the first CORESET. Here, the default beams have a TCI duration equal to or greater than the time offset between reception of the DCI and the multiple physical channel transmissions.

In certain embodiments, the default beam for each scheduled instance of a physical channel is determined based on the associated time duration for the default beam.

In some embodiments, the first apparatus is configured with a time duration for QCL, where the multiple physical channel transmissions are scheduled by a single DCI that does not contain a TCI field, and where a time offset between reception of the DCI and a first portion (or subset) of the multiple physical channel transmissions is less than the time duration for QCL. In such embodiments, communicating with the RAN includes applying a default beam associated with the lowest CORESET ID for the first portion of the multiple physical channel transmissions and switching to a beam associated with the first CORESET for a remaining portion of the multiple physical channel transmissions.

In some embodiments, the first apparatus is configured with a time duration for QCL, where the multiple physical channel transmissions are scheduled by a single DCI that contains a TCI field indicating a set of beams, and where a time offset between reception of the DCI and a first portion (or subset) of the multiple physical channel transmissions is less than the time duration for QCL, wherein communicating with the RAN includes applying a default beam associated with the lowest CORESET ID for the first portion of the multiple physical channel transmissions and switching to the set of beam indicated by the DCI for a remaining portion of the multiple physical channel transmissions.

In some embodiments, the CORESET configuration includes a pattern of beams to monitor for a CORESET, where a periodicity of the pattern is equal to a periodicity of the PDCCH monitoring occasion. In such embodiments, for every PDCCH monitoring occasion (i.e., monitoring period) a same association of beams to monitor for the CORESET is applied within a PDCCH monitoring period.

In some embodiments, the CORESET configuration includes a pattern of beams to monitor for a CORESET, where a periodicity of the pattern is less than a periodicity of the PDCCH monitoring occasion. In such embodiments, for every PDCCH monitoring occasion a same association of beams to monitor for the CORESET is applied within a PDCCH monitoring period.

In some embodiments, the CORESET configuration includes a pattern of beams to monitor for a CORESET, where a periodicity of the pattern is greater than a periodicity of the PDCCH monitoring occasion. In such embodiments, an association of beams to monitor for the CORESET is applied over multiple PDCCH monitoring periods.

In some embodiments, the CORESET configuration includes a plurality of beams (or TCI states or QCL assumptions) associated with multiple Transmission-Reception Points in the RAN.

Disclosed herein is a first method for associating multiple default beams for multiple PDSCH/PUSCH and monitoring of same CORESET on different beams in different monitoring occasions, according to embodiments of the disclosure. The first method may be performed by a UE device entity, such as the remote unit 105, the UE 205, and/or the user equipment apparatus 1000, described above. The first method includes receiving a CORESET configuration from a RAN, said CORESET configuration indicating a plurality of beams (or TCI states or QCL assumptions) and a corresponding duration for each indicated beam for at least CORESET ID. The first method includes monitoring the at least one CORESET in different PDCCH monitoring occasions using different beams and receiving a first CORESET within a PDCCH transmission, the first CORESET scheduling multiple physical channel transmissions (i.e., PDSCH and/or PUSCH). The first method includes communicating with the RAN on the multiple scheduled physical channels using the plurality of beams associated with a lowest CORESET ID configured to the device. Here, communicating with the RAN on the multiple scheduled physical channels includes receiving a downlink transmission, transmitting an uplink transmission, or a combination thereof.

In some embodiments, the UE is configured with a time duration for QCL, where the multiple physical channel transmissions are scheduled by a single DCI that does not contain a TCI field, and where a time offset between reception of the DCI and the multiple physical channel transmissions is equal to or greater than the time duration for QCL. In such embodiments, communicating with the RAN includes applying a default beam (i.e., QCL assumption) associated with the first CORESET (i.e., the CORESET used for the PDCCH transmission). Here, the default beam has a TCI duration equal to or greater than the time offset between reception of the DCI and the multiple physical channel transmissions.

In certain embodiments, the UE applies at least a second default beam when communicating with the RAN on the multiple scheduled physical channels. In such embodiments, the default beam for each scheduled instance of a physical channel is determined based on an associated time duration for the default beam.

In some embodiments, the UE is configured with a time duration for QCL, where the multiple physical channel transmissions are scheduled by a single DCI, and where a time offset between reception of the DCI and the multiple physical channel transmissions is less than the time duration for QCL. In such embodiments, communicating with the RAN on the multiple scheduled physical channels includes applying multiple default beams associated with the first CORESET. Here, the default beams have a TCI duration equal to or greater than the time offset between reception of the DCI and the multiple physical channel transmissions.

In certain embodiments, the default beam for each scheduled instance of a physical channel is determined based on the associated time duration for the default beam.

In some embodiments, the UE is configured with a time duration for QCL, where the multiple physical channel transmissions are scheduled by a single DCI that does not contain a TCI field, and where a time offset between reception of the DCI and a first portion (or subset) of the multiple physical channel transmissions is less than the time duration for QCL. In such embodiments, communicating with the RAN includes applying a default beam associated with the lowest CORESET ID for the first portion of the multiple physical channel transmissions and switching to a beam associated with the first CORESET for a remaining portion of the multiple physical channel transmissions.

In some embodiments, the UE is configured with a time duration for QCL, where the multiple physical channel transmissions are scheduled by a single DCI that contains a TCI field indicating a set of beams, and where a time offset between reception of the DCI and a first portion (or subset) of the multiple physical channel transmissions is less than the time duration for QCL, wherein communicating with the RAN includes applying a default beam associated with the lowest CORESET ID for the first portion of the multiple physical channel transmissions and switching to the set of beam indicated by the DCI for a remaining portion of the multiple physical channel transmissions.

In some embodiments, the CORESET configuration includes a pattern of beams to monitor for a CORESET, where a periodicity of the pattern is equal to a periodicity of the PDCCH monitoring occasion. In such embodiments, for every PDCCH monitoring occasion (i.e., monitoring period) a same association of beams to monitor for the CORESET is applied within a PDCCH monitoring period.

In some embodiments, the CORESET configuration includes a pattern of beams to monitor for a CORESET, where a periodicity of the pattern is less than a periodicity of the PDCCH monitoring occasion. In such embodiments, for every PDCCH monitoring occasion a same association of beams to monitor for the CORESET is applied within a PDCCH monitoring period.

In some embodiments, the CORESET configuration includes a pattern of beams to monitor for a CORESET, where a periodicity of the pattern is greater than a periodicity of the PDCCH monitoring occasion. In such embodiments, an association of beams to monitor for the CORESET is applied over multiple PDCCH monitoring periods.

In some embodiments, the CORESET configuration includes a plurality of beams (or TCI states or QCL assumptions) associated with multiple Transmission-Reception Points in the RAN.

Disclosed herein is a second apparatus for associating multiple default beams for multiple PDSCH/PUSCH and monitoring of same CORESET on different beams in different monitoring occasions, according to embodiments of the disclosure. The second apparatus may be implemented by an access network node, such as the base unit 121, the RAN node 207, and/or the network apparatus 1100, described above. The second apparatus includes a processor coupled to a transceiver, the processor and the transceiver configured to cause the second apparatus to transmit a CORESET configuration to a UE, said CORESET configuration indicating a plurality of beams (or TCI states or QCL assumptions) and a corresponding duration for each indicated beam for at least CORESET ID, and to transmit a first CORESET within a PDCCH monitoring occasion, the first CORESET scheduling multiple physical channel transmissions (i.e., PDSCH and/or PUSCH). Via the transceiver, the processor further communicates with the UE on the multiple scheduled physical channels using the plurality of beams associated with a lowest CORESET ID configured to the device, where communicating with the RAN on the multiple scheduled physical channels includes transmitting a downlink transmission, receiving an uplink transmission, or a combination thereof.

In some embodiments, the CORESET configuration includes a pattern of beams to monitor for a CORESET, where a periodicity of the pattern is equal to a periodicity of the PDCCH monitoring occasion. In such embodiments, for every PDCCH monitoring occasion (i.e., monitoring period) a same association of beams to monitor for the CORESET is applied within a PDCCH monitoring period.

In some embodiments, the CORESET configuration includes a pattern of beams to monitor for a CORESET, where a periodicity of the pattern is less than a periodicity of the PDCCH monitoring occasion. In such embodiments, for every PDCCH monitoring occasion a same association of beams to monitor for the CORESET is applied within a PDCCH monitoring period.

In some embodiments, the CORESET configuration includes a pattern of beams to monitor for a CORESET, where a periodicity of the pattern is greater than a periodicity of the PDCCH monitoring occasion. In such embodiments, an association of beams to monitor for the CORESET is applied over multiple PDCCH monitoring periods.

In some embodiments, the CORESET configuration includes a plurality of beams (or TCI states or QCL assumptions) associated with multiple Transmission-Reception Points in the RAN.

Disclosed herein is a second method for associating multiple default beams for multiple PDSCH/PUSCH and monitoring of same CORESET on different beams in different monitoring occasions, according to embodiments of the disclosure. The second method may be performed by an access network node, such as the base unit 121, the RAN node 207, and/or the network apparatus 1100, described above. The second method includes transmitting a CORESET configuration to a UE, said CORESET configuration indicating a plurality of beams (or TCI states or QCL assumptions) and a corresponding duration for each indicated beam for at least CORESET ID, and transmitting a first CORESET within a PDCCH monitoring occasion, the first CORESET scheduling multiple physical channel transmissions (i.e., PDSCH and/or PUSCH). The second method includes communicating with the UE on the multiple scheduled physical channels using the plurality of beams associated with a lowest CORESET ID configured to the device, where communicating with the RAN on the multiple scheduled physical channels includes transmitting a downlink transmission, receiving an uplink transmission, or a combination thereof.

In some embodiments, the CORESET configuration includes a pattern of beams to monitor for a CORESET, where a periodicity of the pattern is equal to a periodicity of the PDCCH monitoring occasion. In such embodiments, for every PDCCH monitoring occasion (i.e., monitoring period) a same association of beams to monitor for the CORESET is applied within a PDCCH monitoring period.

In some embodiments, the CORESET configuration includes a pattern of beams to monitor for a CORESET, where a periodicity of the pattern is less than a periodicity of the PDCCH monitoring occasion. In such embodiments, for every PDCCH monitoring occasion a same association of beams to monitor for the CORESET is applied within a PDCCH monitoring period.

In some embodiments, the CORESET configuration includes a pattern of beams to monitor for a CORESET, where a periodicity of the pattern is greater than a periodicity of the PDCCH monitoring occasion. In such embodiments, an association of beams to monitor for the CORESET is applied over multiple PDCCH monitoring periods.

In some embodiments, the CORESET configuration includes a plurality of beams (or TCI states or QCL assumptions) associated with multiple Transmission-Reception Points in the RAN.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method at a User Equipment (“UE”), the method comprising:
receiving a control resource set (“CORESET”) configuration from a radio access network (“RAN”), said CORESET configuration indicating a plurality of beams and a corresponding duration for each indicated beam for at least CORESET identifier (“ID”);
monitoring at least one CORESET in different Physical Downlink Control Channel (“PDCCH”) monitoring occasions using different beams;
receiving a first CORESET within a PDCCH transmission, the first CORESET scheduling multiple physical channel transmissions; and
communicating with the RAN on the multiple scheduled physical channels using the plurality of beams associated with a lowest CORESET ID configured to the UE, wherein communicating with the RAN on the multiple scheduled physical channels comprises receiving a downlink transmission, transmitting an uplink transmission, or a combination thereof.

2. The method in claim 1, wherein the UE is configured with a time duration for QCL, wherein the multiple physical channel transmissions are scheduled by a single Downlink Control Information (“DCI”) that does not contain a TCI field, and wherein a time offset between reception of the DCI and the multiple physical channel transmissions is equal to or greater than the time duration for QCL, wherein communicating with the RAN comprises applying a default beam associated with the first CORESET, said default beam having a TCI duration equal to or greater than the time offset between the reception of the DCI and the multiple physical channel transmissions.

3. The method of claim 2, wherein the UE applies at least a second default beam when communicating with the RAN on the multiple scheduled physical channels, wherein the default beam for each scheduled instance of a physical channel is determined based on an associated time duration for the default beam.

4. The method in claim 1, wherein the UE is configured with a time duration for QCL, wherein the multiple physical channel transmissions are scheduled by a single Downlink Control Information (“DCI”), and wherein a time offset between reception of the DCI and the multiple physical channel transmissions is less than the time duration for QCL, wherein communicating with the RAN on the multiple scheduled physical channels comprises applying multiple default beams associated with the first CORESET, said default beams having a TCI duration equal to or greater than the time offset between the reception of the DCI and the multiple physical channel transmissions.

5. The method in claim 4, wherein the default beam for each scheduled instance of a physical channel is determined based on an associated time duration for the default beam.

6. The method of claim 1, wherein the UE is configured with a time duration for QCL, wherein the multiple physical channel transmissions are scheduled by a single Downlink Control Information (“DCI”) that does not contain a TCI field, and wherein a time offset between reception of the DCI and a first portion of the multiple physical channel transmissions is less than the time duration for QCL, wherein communicating with the RAN comprises applying a default beam associated with the lowest CORESET ID for the first portion of the multiple physical channel transmissions and switching to a beam associated with the first CORESET for a remaining portion of the multiple physical channel transmissions.

7. The method of claim 1, wherein the UE is configured with a time duration for QCL, wherein the multiple physical channel transmissions are scheduled by a single Downlink Control Information (“DCI”) that contains a TCI field indicating a set of beams, and wherein a time offset between reception of the DCI and a first portion of the multiple physical channel transmissions is less than the time duration for QCL, wherein communicating with the RAN comprises applying a default beam associated with the lowest CORESET ID for the first portion of the multiple physical channel transmissions and switching to the set of beam indicated by the DCI for a remaining portion of the multiple physical channel transmissions.

8. The method in claim 1, wherein the CORESET configuration comprises a pattern of beams to monitor for a CORESET, wherein a periodicity of the pattern is equal to a periodicity of the PDCCH monitoring occasion, wherein for every PDCCH monitoring occasion a same association of beams to monitor for the CORESET is applied within a PDCCH monitoring period.

9. The method in claim 1, wherein the CORESET configuration comprises a pattern of beams to monitor for a CORESET, wherein a periodicity of the pattern is less than a periodicity of the PDCCH monitoring occasion, wherein for every PDCCH monitoring occasion a same association of beams to monitor for the CORESET is applied within a PDCCH monitoring period.

10. The method in claim 1, wherein the CORESET configuration comprises a pattern of beams to monitor for a CORESET, wherein a periodicity of the pattern is greater than a periodicity of the PDCCH monitoring occasion, wherein an association of beams to monitor for the CORESET is applied over multiple PDCCH monitoring periods.

11. The method in claim 1, wherein the CORESET configuration comprises a plurality of beams associated with multiple Transmission-Reception Points in the RAN.

12. A User Equipment (“UE”) apparatus comprising:
a transceiver; and
a processor coupled to the transceiver, the processor and the transceiver configured to cause the apparatus to:
receive a control resource set (“CORESET”) configuration from a radio access network (“RAN”), said CORESET configuration indicating a plurality of beams and a corresponding duration for each indicated beam for at least CORESET identifier (“ID”);
monitor the at least one CORESET in different Physical Downlink Control Channel (“PDCCH”) monitoring occasions using different beams;
receive a first CORESET within a PDCCH transmission, the first CORESET scheduling multiple physical channel transmissions; and
communicate with the RAN on the multiple scheduled physical channels using the plurality of beams associated with a lowest CORESET ID configured to the apparatus, wherein communicating with the RAN on the multiple scheduled physical channels comprises receiving a downlink transmission, transmitting an uplink transmission, or a combination thereof.

13. A Radio Access Network (“RAN”) apparatus comprising:
a transceiver; and
a processor coupled to the transceiver, the processor and the transceiver configured to cause the apparatus to:
transmit a control resource set (“CORESET”) configuration to a User Equipment (“UE”), said CORESET configuration indicating a plurality of beams and a corresponding duration for each indicated beam for at least CORESET identifier (“ID”);
transmit a first CORESET within a Physical Downlink Control Channel (“PDCCH”) monitoring occasion, the first CORESET scheduling multiple physical channel transmissions; and
communicate with the UE on the multiple scheduled physical channels using the plurality of beams associated with a lowest CORESET ID configured to the UE, wherein communicating with the UE on the multiple scheduled physical channels comprises transmitting a downlink transmission, receiving an uplink transmission, or a combination thereof.

14. The apparatus in claim 13, wherein the CORESET configuration comprises a pattern of beams to monitor for a CORESET, wherein a periodicity of the pattern is less than or equal to a periodicity of the PDCCH monitoring occasion, wherein for every PDCCH monitoring occasion a same association of beams to monitor for the CORESET is applied within a PDCCH monitoring period.

15. The apparatus in claim 13, wherein the CORESET configuration comprises a pattern of beams to monitor for a CORESET, wherein a periodicity of the pattern is greater than a periodicity of the PDCCH monitoring occasion, wherein an association of beams to monitor for the CORESET is applied over multiple PDCCH monitoring periods.
